(19) United States
(12) Patent Application Publication
(10) Pub. No.: US 2025/0326120 A1
(43) Pub. Date: Oct. 23, 2025

(54) INFORMATION PROCESSING APPARATUS, INFORMATION PROCESSING METHOD, AND RECORDING MEDIUM

(71) Applicant: Konica Minolta, Inc., Tokyo (JP)

(72) Inventor: Yushi Komaki, Toyokawa-shi (JP)

(73) Assignee: Konica Minolta, Inc., Tokyo (JP)

(21) Appl. No.: 19/181,675

(22) Filed: Apr. 17, 2025

(30) Foreign Application Priority Data
Apr. 18, 2024 (JP) 2024-067300

(51) Int. Cl. B25J 9/16

(52) U.S. Cl. CPC B25J 9/1666

(57) ABSTRACT

Disclosed is an information processing apparatus including a hardware processor that: acquires each of information on a robot and information on an obstacle; sets a first clearance amount in a section in which the robot changes from a first posture to a second posture and a second clearance amount in a section in which the robot changes from the second posture to a third posture; and when determining, based on the acquired information and a set clearance amount, whether the robot and the obstacle interfere with each other in the second posture, performs determination based on a greater one of the first clearance amount and the second clearance amount.

### BACKGROUND OF THE INVENTION

### Technical Field

The present invention relates to an information processing apparatus, an information processing method, and a recording medium.

### Description of Related Art

As an example of the information processing apparatus, there is a robot simulator that reproduces a real environment on a virtual environment before actually moving a robot. The robot simulator is a simulator capable of automatically generating a path along which a robot moves while avoiding interference with an obstacle in a section connecting postures of the robot (for example, see Japanese Patent No. 7147571). Japanese Patent No. 7147571 discloses a technique of acquiring information on a robot and an obstacle, setting a clearance amount for avoiding interference between the robot and the obstacle based on the acquired information, and generating a path of the robot based on the set clearance amount.

### SUMMARY OF THE INVENTION

Incidentally, in order to generate the path of the robot, it is necessary to determine in advance a posture for creating a section and to confirm that the posture does not interfere with an obstacle. In the case of a simulator in which a uniform clearance amount is set for every section when a route of a plurality of sections is generated, a large clearance amount is set in accordance with other sections even in a section in which it is not necessary to set a large clearance amount. In this way, when a larger clearance amount than necessary is set for a section for which it is not necessary to set a large clearance amount, a generated route becomes unnecessarily large, and thus the tact time becomes longer.

On the other hand, in a case where a different clearance amount can be set for each section in which a route is generated, in order to confirm that the posture does not interfere with the obstacle, the clearance amount set for each section is also applied to each posture to perform the interference check. At this time, depending on the clearance amount of which section is applied to each posture, a situation in which interference necessarily occurs in subsequent path generation may occur.

An object of the present invention is to provide an information processing apparatus, an information processing method, and a recording medium capable of eliminating a situation in which interference necessarily occurs in route generation if it is determined that there is no interference in a set posture when a clearance amount different for each section in which a route is generated is set.

To achieve at least one of the abovementioned objects, according to an aspect of the present invention, information processing apparatus reflecting one aspect of the present invention comprises a hardware processor that:
acquires each of information on a robot and information on an obstacle;
sets a first clearance amount in a section in which the robot changes from a first posture to a second posture and a second clearance amount in a section in which the robot changes from the second posture to a third posture; and
when determining, based on the acquired information and a set clearance amount, whether the robot and the obstacle interfere with each other in the second posture, performs determination based on a greater one of the first clearance amount and the second clearance amount.

To achieve at least one of the abovementioned objects, according to another aspect of the present invention, information processing method reflecting one aspect of the present invention comprises:
acquiring that is acquiring each of information on a robot and information on an obstacle;
setting that is setting a first clearance amount in a section in which the robot changes from a first posture to a second posture and a second clearance amount in a section in which the robot changes from the second posture to a third posture; and
determining that is, when determining whether the robot and the obstacle interfere with each other in the second posture based on the information acquired in the acquiring and a clearance amount that is set in the setting, performing determination based on a greater one of the first clearance amount and the second clearance amount.

To achieve at least one of the abovementioned objects, according to another aspect of the present invention, recording medium reflecting one aspect of the present invention is a non-transitory computer-readable recording medium storing a program for causing a computer to execute:
acquiring that is acquiring each of information on a robot and information on an obstacle;
setting that is setting a first clearance amount in a section in which the robot changes from a first posture to a second posture and a second clearance amount in a section in which the robot changes from the second posture to a third posture; and
determining that is, when determining whether the robot and the obstacle interfere with each other in the second posture based on the information acquired in the acquiring and a clearance amount that is set in the setting, performing determination based on a greater one of the first clearance amount and the second clearance amount.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 is a functional block diagram illustrating an example of a functional configuration of a robot simulator according to an embodiment of the present invention;

FIG. 2 is a block diagram illustrating an example of a hardware configuration in a case where a robot simulator according to an embodiment of the present invention is configured by a computer;

FIG. 3 is a schematic perspective view showing a configuration example of a robot which is a control target of the robot simulator;

FIG. 4 is a diagram illustrating joint numbers of a 6-joint (6-axis) robot and angles of the respective joints;

FIG. 5 is a diagram illustrating another state of the joint in which the same position and angle of the hand as those in the case of FIG. 4 can be realized;

FIG. 6 is a diagram illustrating a state where a way point connects between nodes;

FIG. 7 is a diagram illustrating a state when generating a path along which the robot moves from the posture to the posture b and from the posture b to the posture c;

FIG. 8 is a flowchart illustrating a flow of processing according to Example 1 in a robot simulator according to an embodiment of the present invention;

FIG. 9 is a flowchart illustrating a flow of processing according to Example 2 in a robot simulator according to an embodiment of the present invention;

FIG. 10 is a flowchart illustrating a flow of processing according to Example 3 in a robot simulator according to an embodiment of the present invention;

FIG. 11 is a flowchart illustrating a flow of processing according to Example 4 in a robot simulator according to an embodiment of the present invention;

FIG. 12 is a flowchart illustrating a flow of processing according to Example 5 in a robot simulator according to an embodiment of the present invention; and

FIG. 13 is a flowchart illustrating a flow of processing according to Example 6 in the robot simulator according to an embodiment of the present invention.

### DETAILED DESCRIPTION

Hereinafter, the forms which embody the present invention (embodiments) will be described with reference to the accompanying drawings. However, the scope of the invention is not limited to the disclosed embodiments. In this specification and the drawings, components having substantially the same functions or configurations are denoted by the same reference numerals, and redundant description thereof will be omitted.

### Robot Simulators According to an Embodiment of the Present Invention

A robot simulator according to an embodiment of the present invention is an example of an information processing apparatus. The robot simulator according to the present embodiment is a simulator that reproduces a real environment on a virtual environment before actually moving a robot.

### Example of Functional Configuration of Robot Simulator

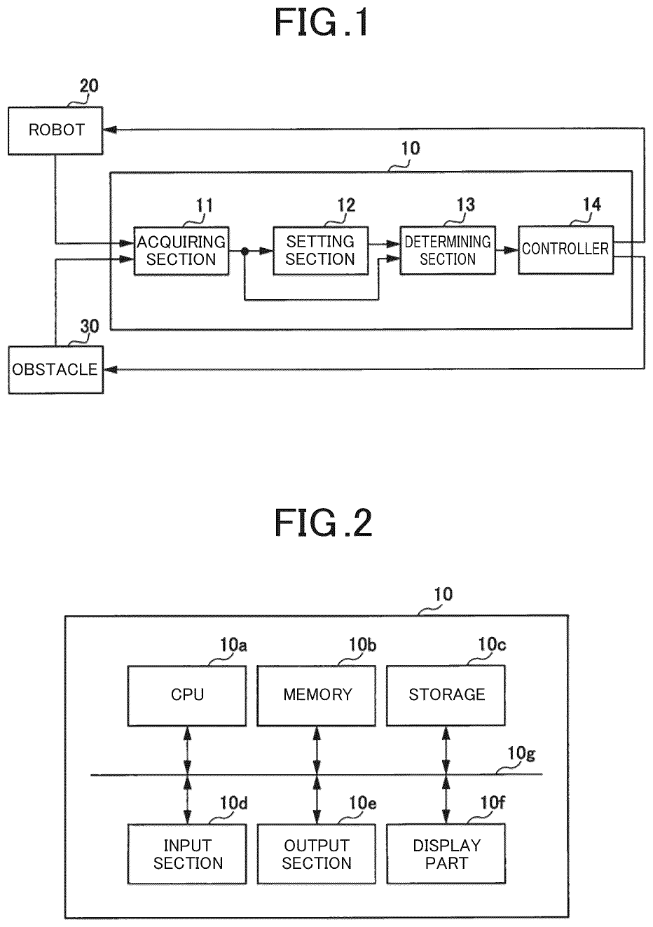

FIG. 1 is a functional block diagram illustrating an example of a functional configuration of a robot simulator according to an embodiment of the present invention. As illustrated in FIG. 1, a robot simulator 10 according to the present embodiment includes an acquiring section 11, a setting section 12, a determining section 13, and a controller 14, and targets a robot 20 and an obstacle 30 for control. The robot 20 is, for example, an industrial robot. Note that the robot simulator 10, the robot 20, and the obstacle 30 may have an integrated system configuration.

In the robot simulator 10 having the above-described configuration, the acquiring section 11 acquires information on the robot 20 and information on the obstacle 30. The information on the robot 20 is, for example, posture information and position information of the robot 20. The information on the obstacle 30 is, for example, position information and shape information of the obstacle 30. These pieces of information are useful for automatically generating a path along which the robot 20 moves in the sections connecting between the postures of the robot 20 while avoiding interference with the obstacle.

Based on the information acquired by the acquiring section 11, the setting section 12 sets a different clearance amount for each section connecting the postures as the clearance amount for avoiding the interference between the robot 20 and the obstacle 30 in the change between the postures of the robot 20. More specifically, in consecutive first, second, and third postures, the setting section 12 sets a first clearance amount in a section in which the robot 20 changes from the first posture to the second posture and a second clearance amount in a section in which the robot 20 changes from the second posture to the third posture.

The determining section 13 determines, based on the information acquired by the acquiring section 11 and the clearance amount set by the setting section 12, whether the robot 20 and the obstacle 30 interfere with each other in a section connecting between the postures of the robot 20. Next, the determining section 13 determines, in the determination in the second posture, whether the robot 20 and the obstacle 30 interfere with each other, based on the greater clearance amount of the first clearance amount and the second clearance amount. Details of the determination processing performed by the determining section 13 will become apparent from the following description.

The controller 14 controls, based on the determination result of the determining section 13, the position of the robot 20, the position of the obstacle 30, or the clearance amount set by the setting section 12. Details of the control by the controller 14 will become apparent from the following description.

The information processing method of the present invention is an information processing method in the robot simulator 10 according to the present embodiment having the above configuration.

### Hardware Configuration Example of Robot Simulator

FIG. 2 is a block diagram illustrating an example of a hardware configuration in a case where the robot simulator 10 according to an embodiment of the present invention is configured with a computer.

As illustrated in FIG. 2, the robot simulator 10 according to the present embodiment is configured by a computer including a CPU 10a (hardware processor), a memory 10b, a storage 10c, an input section 10d, an output section 10e, and a display part 10f. The CPU 10a, the memory 10b, the storage 10c, the inputting section 10d, the outputting section 10e, and the display part 10f are respectively connected to the bus 10g. The CPU is an abbreviation of Central Processing Unit.

The CPU 10a is an arithmetic processing section that reads, from the memory 10b, a program code of software that implements a function performed by the robot simulator 10 and executes the program code. The functions performed by the robot simulator 10 are the functions of the functional units of the acquiring section 11, the setting section 12, the determining section 13, and the controller 14 illustrated in FIG. 1. Further, the information processing method of the present invention can be executed by the functions performed by the robot simulator 10. The program code of the software for realizing the functions performed by the robot simulator 10 may be read from the storage 10c by the CPU 10a.

When the CPU 10a reads the program code and executes arithmetic processing in the work area of the memory 10b, various processing functional units are configured in the memory 10b. For example, the functions of the acquiring section 11, the setting section 12, the determining section 13, and the controller 14 illustrated in FIG. 1 are configured in the memory 10b that stores the program code of the software that realizes the functions performed by the robot simulator 10.

The storage 10c is large-capacity information storage media such as a hard disk drive (HDD), a solid state drive (SSD), and a memory card. The storage 10c stores software for realizing functions of the robot simulator 10 and information obtained by executing the software.

The input section 10d includes input devices such as a keyboard and a mouse. The user inputs various kinds of information by operating the input section 10d.

The output section 10e outputs a processing result or the like in the robot simulator 10 to the outside. The output section 10e directly controls the robot 20 on the basis of a processing result in the robot simulators 10. In this case, the output section 10e supplies a processing result in the robot simulator 10 to a drive mechanism such as joints.

The display part 10f performs processing of displaying a processing result or the like in the robot simulator 10. Note that the control of the robot 20 by the robot simulator 10 is an example, and the robot simulator 10 may only output the calculation result.

### Configuration Example of Robot

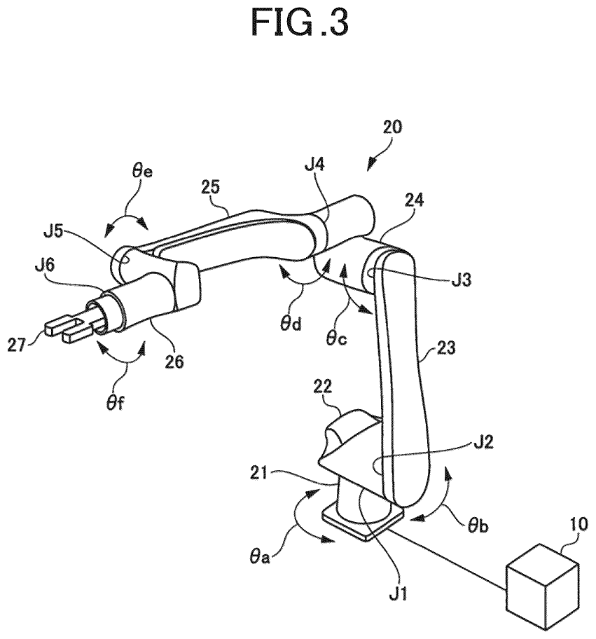

FIG. 3 is a schematic perspective view showing a configuration example of a robot 20 which is a control target of the robot simulator 10. The robot 20 exemplified herein is an articulated robot in which a plurality of links are rotatably connected to each other by joint sections. A robot simulator 10 according to an embodiment of the present invention is connected to the robot 20.

As shown in FIG. 3, the robot 20 has a configuration in which arm-shaped links 23, 24, 25, and 26 are connected to a base 21. The links 23, 24, 25, and 26 are sequentially connected via joints J1, J2, J3, J4, and J5. A hand 27, which is a distal end instrument, is attached to the distal end link 26 via a joint J6. The hand 27 performs an operation of gripping an article or the like.

The joints J1 to J6 are configured to move within movable ranges indicated by angles θa to θf illustrated in FIG. 3. That is, the robot 20 according to the present example is an articulated robot including a large number of joints such as six joints (six axes), and can freely move the distal end portion of the link 26 at the distal end or the distal end portion of the hand 27 in three axial directions of the X axis, the Y axis, and the Z axis. The rotation of the joints J1 to J6 and the operation of the hand 27 are executed under the control of the controller 14 (see FIG. 1) of the robot simulator 10 connected to the robot 20.

As described above, the robot 20 basically includes a plurality of links 23, 24, 25, and 26 and joints J1, J2, J3, J4, and J5. Then, when the joints J1, J2, J3, J4, and J5 move within the movable range of the angles θa to θf, the links 23, 24, 25, and 26 connected to the joints J1, J2, J3, J4 and J5. Further, by appropriately controlling the angles of the joints J1, J2, J3, J4, and J5, it is possible to cause the entire robot 20 to make a meaningful motion.

### Posture of Robot and State of Joints

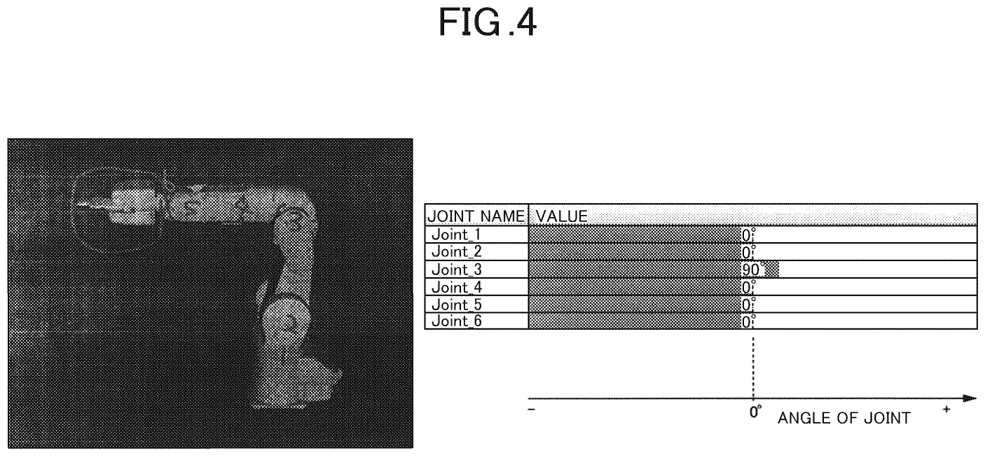

FIG. 4 is a diagram illustrating an posture of the robot 20 and a state of joints. FIG. 4 shows the joint numbers 1 to 6 of the six joint (six axis) robot 20 and the angles of the joints J1, J2, J3, J4, J5, and J6. The controller 14 can determine the posture of the robot 20 by changing the angles of the joints J1, J2, J3, J4, J5, and J6.

A hand 27 corresponding to work is attached to a link 26 at the tip of the robot 20 via a joint J6. In order for the robot 20 to perform work, first, it is necessary to set the working point (which is often the tip) of the hand 27 to a desired position and a desired angle. There is not one but a plurality of sets of angles of the joints of the robot 20 satisfying the working points in FIG. 4.

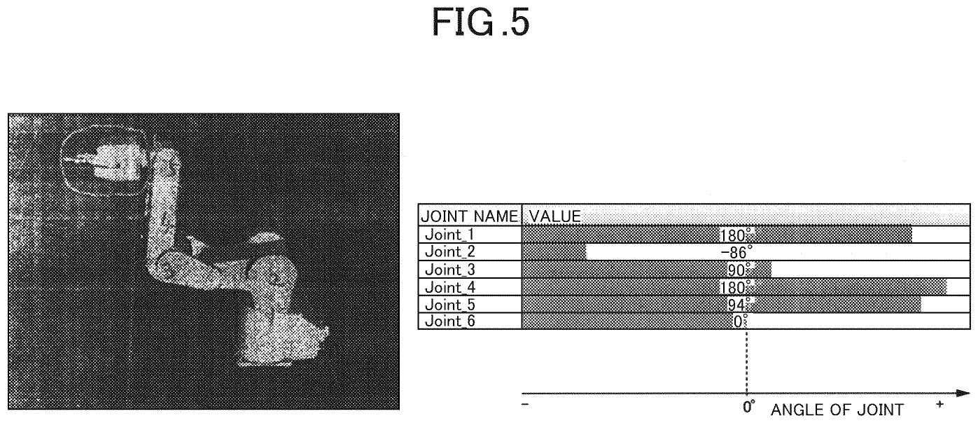

FIG. 5 is a diagram illustrating another state of the joints in which the same position and angle of the hand 27 as those in the case of FIG. 4 can be achieved. As illustrated in FIG. 5, it can be understood that there are other sets of joint angles that can realize the same position and angle of the hand as the position and angle of the hand 27 in FIG. 4.

In order for the robot 20 to work, it is not sufficient for the hand 27 to be stationary in a state of being at a desired position and angle, and it is necessary to move the hand 27 to another predetermined position and angle.

As described above, the position and the angle are designated for each target of the hand 27, and the information of the position and the angle is collectively referred to as a “node”. The robot 20 can perform a task by following a predetermined node in a predetermined order.

### Regarding Route Creation Algorithm

Usually, since the nodes are separated from each other to some extent, a route creation algorithm is used to determine how to move the respective joints J1, J2, J3, J4, J5, and J6 when moving from one node to another node.

The route creation algorithm derives angles of the respective joints J1, J2, J3, J4, J5, and J6 so as not to interfere with obstacles at some intermediate points between the nodes until the robot moves from one node to another node. A set of angles of a plurality of joints at these waypoints is referred to as a “waypoint”.

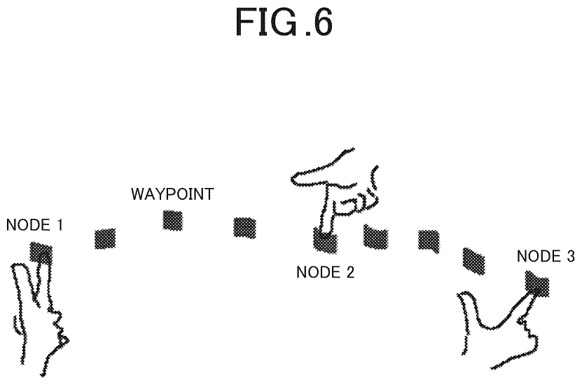

FIG. 6 is a diagram showing a state in which waypoints connect nodes. The process of creating waypoints using the route creation algorithm is a process of generating a route.

The route creation algorithm sequentially provides information on the way points to the actual robot. The robot moves the joints to achieve the joint angles of the given waypoints in sequence.

Problem when Applying Clearance Amount Set in Section to Posture

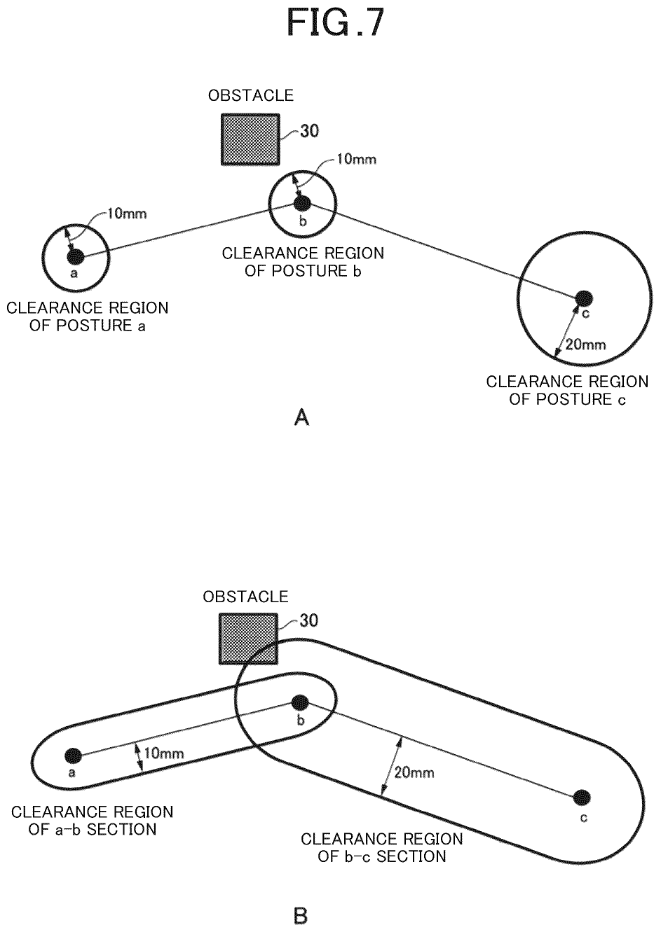

Incidentally, in a robot simulator capable of setting a different clearance amount for each section for which a path is generated, it is necessary to determine the posture of the robot 20 for creating the section before generating the path, and to confirm that the posture does not interfere with an obstacle. Then, in order to confirm that the posture of the robot 20 does not interfere with the obstacle 30, the clearance amount set for each section is also applied to each posture to perform the interference check. At this time, depending on which section's clearance amount is to be applied to each posture, there is a condition that the subsequent route generation will always fail. This condition will be clarified in the description with reference to FIG. 7.

FIG. 7 is a diagram illustrating a state when the robot 20 generates a path along which the robot 20 moves from the posture to the posture b and from the posture b to the posture c. FIG. 7a illustrates a state in which a clearance amount set for a section is applied to a goal posture, and FIG. 7b illustrates a state of interference check in which a route is generated with the clearance amount set for the section.

In one example, it is assumed that the clearance amount in an a-b section in which the robot 20 moves from the posture to the posture b is set as 10 mm, and the clearance amount in a b-c section in which the robot 20 moves from the posture b to the posture c is set as 20 mm. The route creation algorithm applies the clearance amount set for the section to each of the postures a, b, and c in order to check whether or not each of the postures a, b, and c interferes with the obstacle 30 before generating the route. At this time, the path creation algorithm applies the clearance amount of the a-b section to the posture a and the posture b included in the a-b section which is the head section, and sets the clearance amount of the posture to 10 mm and the clearance amount of the posture b to 10 mm. The route creation algorithm applies the clearance amount for the b-c section to the posture c for which the clearance amount has not been set, out of the posture b and the posture c included in the b-c section that is the next section, and assigns 20 mm to the clearance amount for the posture c.

When the interference check is executed with the clearance amounts applied to the postures a, b, and c in this way, as shown in FIG. 7a, it is determined that there is no interference because the obstacle 30 does not exist in the clearance region in any posture. However, if an attempt is made to execute route generation in this state, as shown in FIG. 7b, the obstacle 30 exists in the clearance region of the b-c section, and therefore, route generation necessarily fails.

Therefore, the robot simulator 10 according to the present embodiment is based on the premise that a different clearance amount can be set for each section for which a path is generated. Then, when setting the clearance amount for a posture extending over a plurality of sections, the robot simulator 10 according to the present embodiment applies the larger clearance amount among the clearance amounts for the section including the posture.

In the case of the above-described example, the route creation algorithm applies the clearance amount 20 mm, which is the greater of the clearance amounts in the a-b section and the b-c section, as the clearance amount for the corresponding posture b, and executes the interference check with this applied clearance amount. As a result, it is possible to eliminate a situation in which interference necessarily occurs in path generation if there is no interference in the set posture.

Hereinafter, specific Example 1 to Example 6 of processing in the robot simulator 10 according to the present embodiment, specifically, determination processing of the determining section 13 and control of the controller 14 in FIG. 1 will be described.

### Example 1

Example 1 is an example of processing in which a clearance amount in a section for which a route is generated is applied to a posture to perform an interference check on the posture. The process according to the Example 1 is an example of a process of generating a path that sequentially passes through n postures of the posture P₁, the posture P₂, the posture P₃, ***, and the posture Pₙ.

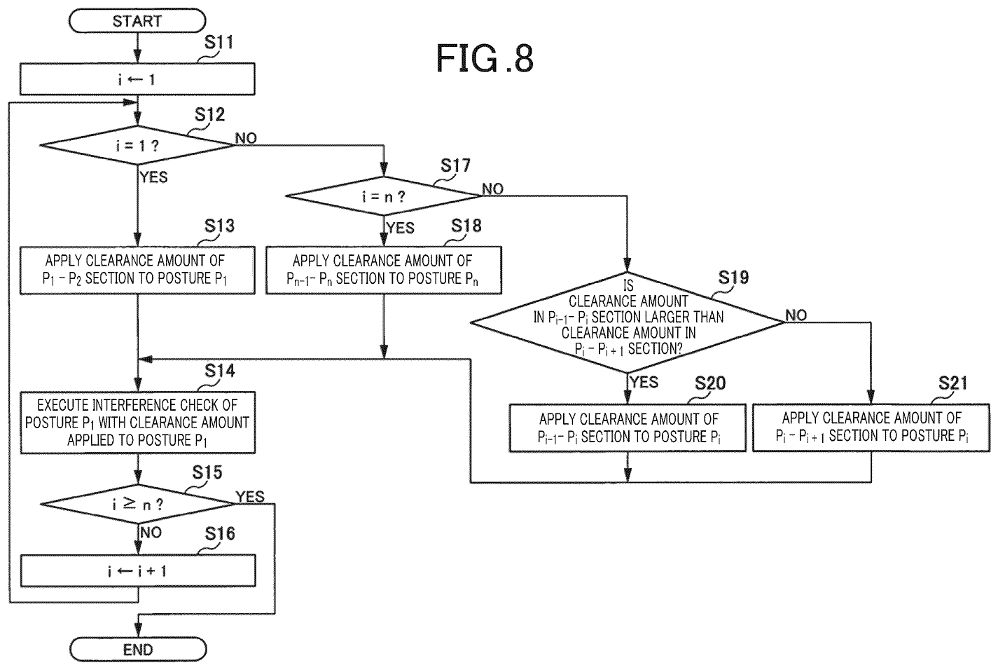

FIG. 8 is a flowchart showing a flow of processing according to Example 1 in the robot simulator 10 according to the present embodiment. The process according to Example 1 is a process performed by the determining section 13 in FIG. 1.

The determining section 13 first assigns 1 to an posture number i (step S11) and then determines whether I=1 is satisfied (step S12). If i=1 (YES in step S12), since the posture P₁ is included only in the P₁-P₂ section, the clearance amount of the P₁-P₂ section is applied to the posture P₁ (step S13).

Next, the determining section 13 executes the interference check of the posture P₁ with the clearance amount applied to the posture P₁ (step S14). Then, the determining section 13 determines whether or not the posture number i is n or more (i≥n) (step S15). Then, when the posture number I is n or more (YES in S15), the determining section 13 ends a series of processing, and when the posture number I is not n or more (NO in S15), the determining section 13 increments the posture number I (step S16) and returns to step S12.

When determining in step S12 that I=1 is not satisfied (NO in S12), the determining section 13 determines whether or not I=n is satisfied (step S17). If I=n (YES in step S17), the posture Pₙ, which is the last posture, is included only in the Pₙ₋₁-Pₙ section. Therefore, the determining section 13 applies the clearance amount of the Pₙ₋₁-Pₙ section to the posture Pₙ (step S18). Thereafter, the process proceeds to step S14, and the interference check of the posture Pₙ is executed with the clearance amount applied to the posture Pₙ.

When determining in step S17 that I=n does not hold (NO in S17), the determining section 13 determines whether or not the clearance amount in the Pᵢ₋₁-Pᵢ section is larger than the clearance amount in the Pᵢ-Pᵢ₊₁ section (step S19). Then, when the clearance amount of the Pᵢ₋₁-Pᵢ section is larger than the clearance amount of the Pᵢ-Pᵢ₊₁ section (YES in S19), the determining section 13 applies the clearance amount of the Pᵢ₋₁-Pᵢ section to the posture Pᵢ (step S20). Thereafter, the determining section 13 proceeds to step S14 and performs the interference check of the posture Pᵢ with the clearance amount applied to the posture Pᵢ.

When it is determined that the clearance amount of the Pᵢ₋₁-Pᵢ section is not larger than the clearance amount of the Pᵢ-Pᵢ₊₁ section in step S19 (NO in S19), the determining section 13 applies the clearance amount of the Pᵢ-Pᵢ₊₁ section to the posture Pᵢ (step S21)). Then, the determining section 13 proceeds to step S14 and performs the interference check of the posture Pᵢ with the clearance amount applied to the posture Pᵢ.

The determining section 13 performs the above-described series of processes on all the postures from the first posture P₁ to the last posture Pₙ.

As described above, the posture Pᵢ which is neither the first posture P₁ nor the last posture Pₙ is included in the two sections of the Pᵢ₋₁-Pᵢ section and the Pᵢ-Pᵢ₊₁ section. In the processing according to Example 1, for the postures included in such two sections, the clearance amounts set for the two sections are compared with each other, and the larger clearance amount is applied to perform the interference check. As a result, it is possible to eliminate a situation in which interference necessarily occurs in path generation if there is no interference in the set posture.

### Example 2

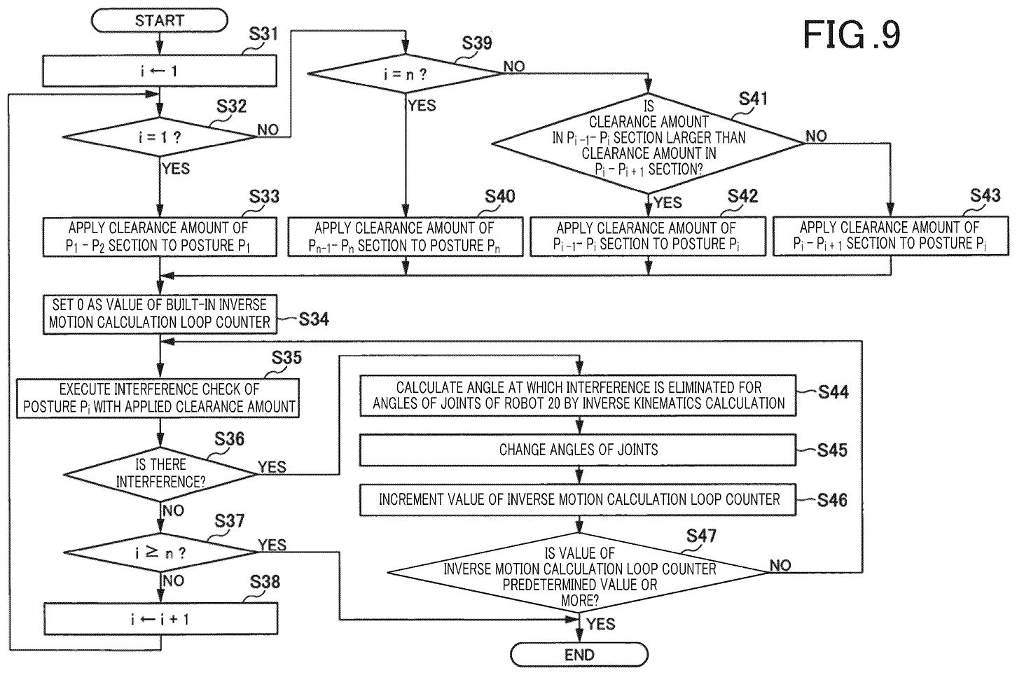

Example 2 is a processing example in which the angle of the joint is changed to an angle at which the interference is eliminated when the interference occurs in the posture. FIG. 9 is a flowchart showing a flow of processing according to Example 2 in the robot simulator 10 according to the present embodiment. The processing according to Example 2 is processing performed by the determining section 13 and the controller 14 in FIG. 1.

In the flowchart of FIG. 9, each processing of steps S31 to S33 and each processing of steps S39 to S43 are the same as each processing of steps S11 to S13 and each processing of steps S17 to S21 in the flowchart of FIG. 8. Here, redundant description will be omitted.

After each processing of step S33, step S40, step S42, and step S43, the determining section 13 sets 0 as the value of the built-in inverse motion calculation loop counter (step S34). Next, the determining section 13 executes the posture Pᵢ interference check with the applied clearance amount (step S35).

Next, the determining section 13 determines whether or not the result of the interference check indicates interference (step S36), and if there is no interference (NO in S36), the determining section 13 determines whether or not the posture number I is n or more (i≥n) (step S37). If the posture number I is equal to or larger than n (YES in S37), a series of processing is terminated. If the posture number I is not equal to or larger than n (NO in S37), the posture number I is incremented (step S38), and the process returns to step S32.

In step S36, when the determination result of the determining section 13 is that the result of the interference check is interference (YES in S36), in response to the determination result, the controller 14 calculates an angle at which interference is eliminated for the angles of the joints of the robot 20 by inverse kinematics calculation (step S44). Then, the controller 14 changes the angles of the joints of the robot 20 to the calculated angles (step S45).

Thereafter, the determining section 13 increments the value of the inverse motion calculation loop counter (step S46), and then determines whether or not the value of the inverse motion calculation loop counter is equal to or more than a predetermined value set in advance (step S47). Then, if it is equal to or greater than the predetermined value (YES in S47), the determining section 13 ends the series of processes, and if it is not equal to or greater than the predetermined value (NO in S47), the process returns to step S35.

As described above, in the processing according to Example 2, when it is determined that there is interference in the interference check of the postures, the angles of the joints of the robot 20 are calculated by the inverse kinematics calculation until the interference is eliminated. Thus, when the interference occurs in the posture, the angle of the joint can be changed to an angle at which the interference is eliminated.

If the interference is not eliminated even if the above-described series of processing is repeated a predetermined number of times (the predetermined value in step S47), the processing is terminated. In a case where the obstacle 30 is present at the target position of the robot 20, or in a case where the base of the robot 20 and the obstacle 30 interfere with each other, the interference cannot be eliminated no matter how much the angle of the joint of the robot 20 is changed. Therefore, the determining section 13 ends the processing after repeating the processing a predetermined number of times so as not to form an infinite loop. The determining section 13 executes this series of processing a number of times equal to the number of postures. Here, the target position of the robot 20 is the position of the tip part of the robot 20.

### Example 3

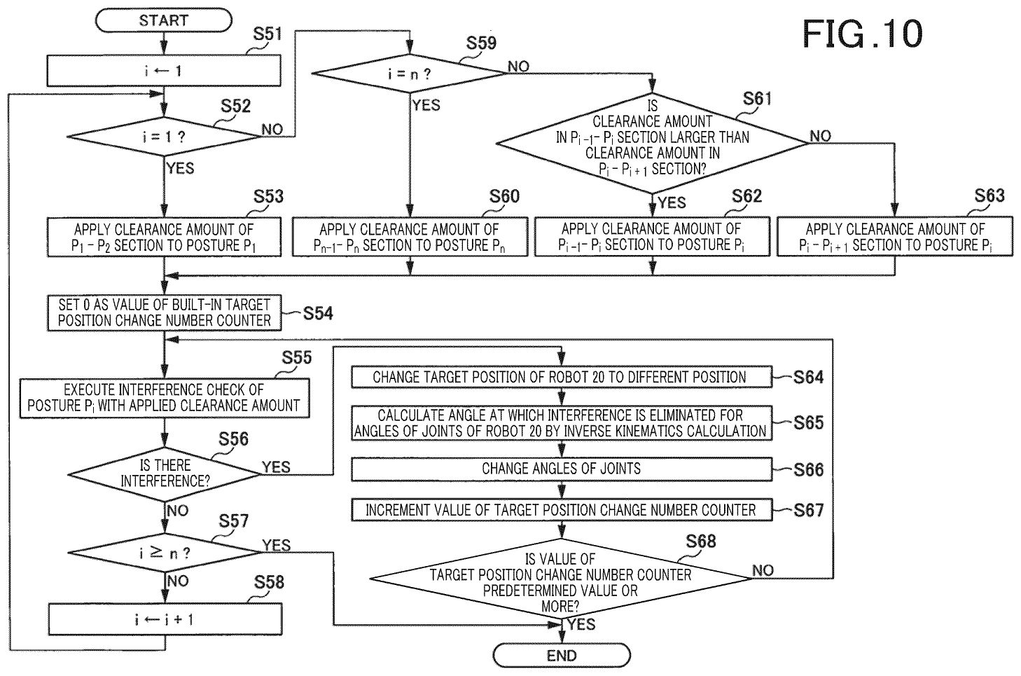

Example 3 is a processing example in which the target position of the robot 20 is changed to a position where the interference is eliminated when the interference occurs in the posture. FIG. 10 is a flowchart showing a flow of processing according to Example 3 in the robot simulator 10 according to the present embodiment. The processing according to Example 3 is processing performed by the determining section 13 and the controller 14 in FIG. 1.

In the flowchart of FIG. 10, each processing of steps S51 to S53 and each processing of steps S59 to S63 are the same as each processing of steps S11 to S13 and each processing of steps S17 to S21 in the flowchart of FIG. 8. Here, redundant description will be omitted.

After each of the processes of step S53, step S60, step S62, and step S63, the determining section 13 sets 0 as the value of a built-in target position change number counter (step S54). Next, the determining section 13 executes the posture Pᵢ interference check with the applied clearance amount (step S55).

Next, the determining section 13 determines whether or not the result of the interference check indicates interference (step S56), and if there is no interference (NO in S56), the determining section 13 determines whether or not the posture number I is n or more (i≥n) (step S57). If the posture number I is equal to or larger than n (YES in S57), a series of processing is terminated. If the posture number I is not equal to or larger than n (NO in S57), the posture number I is incremented (step S58), and the process returns to step S52.

In step S56, if the determination result of the determining section 13 indicates that the result of the interference check indicates interference (YES in S56), in response to the determination result, the controller 14 changes the target position of the robot 20 to a different position (step S64).

Next, based on the changed target positions, the controller 14 calculates, by inverse kinematics calculation, angles of the joints of the robot 20 at which the interferences are eliminated (step S65), and then changes the angles of the joints of the robot 20 to the calculated angles (step S66).

Thereafter, the determining section 13 increments the value of the target position change number counter (step S67), and then determines whether or not the value of the target position change number counter is equal to or more than a predetermined value set in advance (step S68). Then, if it is equal to or greater than the predetermined value (YES in S68), the determining section 13 ends the series of processes, and if it is not equal to or greater than the predetermined value (NO in S68), the process returns to step S55.

As described above, in the process according to Example 3, when it is determined that there is interference in the posture interference check, the target position of the robot 20 is changed to a different position, that is, a position at which the interference is eliminated. Then, in the processing according to Example 3, the inverse motion calculation is performed based on the changed target position, the angle of the joint of the robot 20 is calculated, and the interference check is executed in the posture of the calculated angle of the joint. Thus, when interference occurs in the posture, the target position of the robot 20 can be changed to a position at which the interference is eliminated.

The above-described process is repeatedly executed until the interference is eliminated, and when the interference is not eliminated even if the process is repeated a predetermined number of times (the predetermined value of step S68), the process is terminated. In a case where the base of the robot 20 and the obstacle 30 interfere with each other, the interference cannot be eliminated no matter how much the target position is changed. Therefore, in the processing according to Example 3, the processing is ended after being repeated a predetermined number of times so as not to become an infinite loop. The determining section 13 and the controller 14 perform this series of processing for the number of postures.

### Example 4

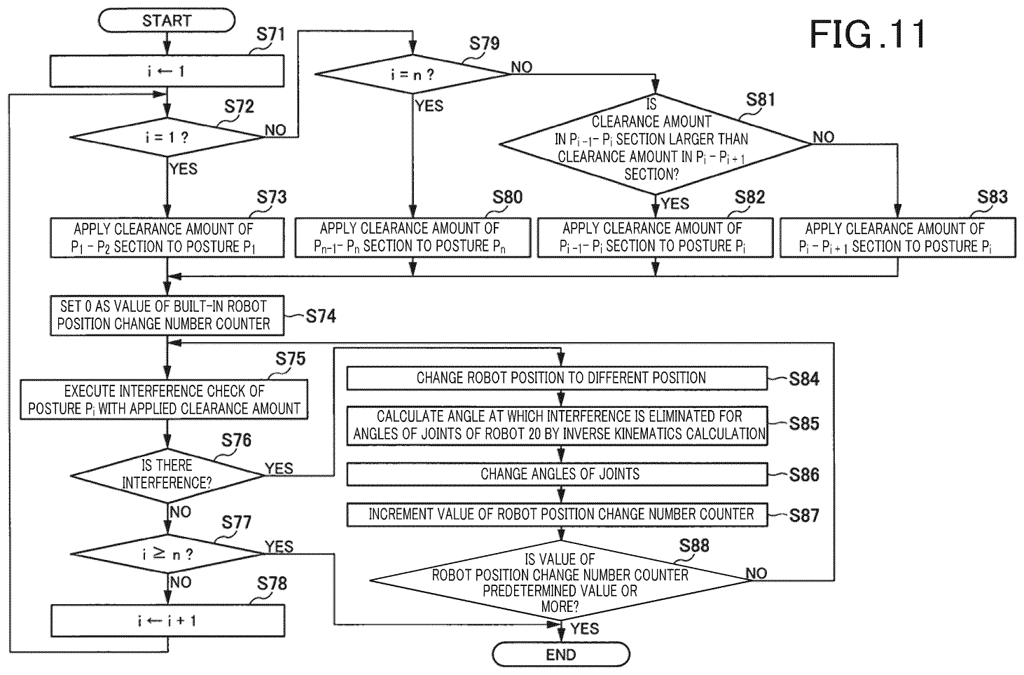

Example 4 is a processing example in which the position of the robot 20 is changed to a position at which interference is eliminated when the interference occurs in the posture. FIG. 11 is a flowchart showing a flow of processing according to Example 4 in the robot simulator 10 according to the present embodiment. The process according to Example 4 is a process performed by the determining section 13 and the controller 14 in FIG. 1.

In the flowchart of FIG. 11, each processing of steps S71 to S73 and each processing of steps S79 to S83 are the same as each processing of steps S11 to S13 and each processing of steps S17 to S21 in the flowchart of FIG. 8. Here, redundant description will be omitted.

After each of the processes of step S73, step S80, step S82, and step S83, the determining section 13 sets 0 as the value of a built-in robot position change number counter (step S74). Next, the determining section 13 executes the posture Pᵢ interference check with the applied clearance amount (step S75).

Next, the determining section 13 determines whether or not the result of the interference check indicates interference (step S76), and if there is no interference (NO in S76), the determining section 13 determines whether or not the posture number I is n or more (i≥n) (step S77). If the posture number I is equal to or larger than n (YES in S77), a series of processing is terminated. If the posture number I is not equal to or larger than n (NO in S77), the posture number I is incremented (step S78), and the process returns to step S72.

In step S76, when the determination result of the determining section 13 is that the result of the interference check is interference (YES in S76), the controller 14 changes the robot position to a different position in response to the determination result (step S84).

Next, based on the changed position of the robot 20, the controller 14 calculates, by inverse kinematics calculation, angles of the joints of the robot 20 at which the interferences are eliminated (step S85), and then changes the angles of the joints of the robot 20 to the calculated angles (step S86).

Thereafter, the determining section 13 increments the value of the robot position change number counter (step S87), and then determines whether or not the value of the robot position change number counter is equal to or more than a predetermined value set in advance (step S88). Then, if it is equal to or greater than the predetermined value (YES in S88), the determining section 13 ends the series of processes, and if it is not equal to or greater than the predetermined value (NO in S88), the process returns to step S75.

As described above, in the processing according to Example 4, if it is determined that there is interference in the posture interference check, the robot position is changed to a different position. Here, the robot position is a position where the robot 20 is installed. The controller 14 performs inverse motion calculation based on the changed robot position and the already set target position to calculate the angles of the joints of the robot 20. Then, the determining section 13 performs the interference check with the posture of the calculated angle of the joint. Thus, when interference occurs in the posture, the position of the robot 20 can be changed to a position at which the interference is eliminated.

The above-described process is repeatedly executed until the interference is eliminated, and when the interference is not eliminated even if the process is repeated a predetermined number of times (the predetermined value of step S88), the process is terminated. When the obstacle 30 is present at the target position, the interference cannot be eliminated no matter how much the robot position is changed. Therefore, in the processing according to Example 4, the processing ends after being repeated a predetermined number of times so as not to become an infinite loop. The determining section 13 and the controller 14 perform this series of processing for the number of postures.

### Example 5

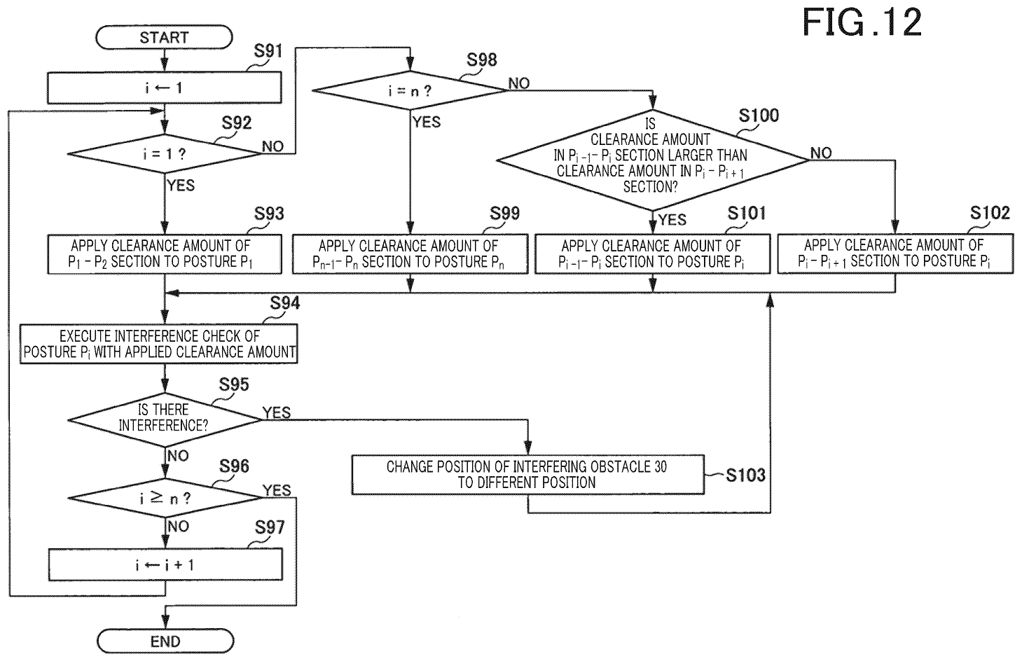

Example 5 is a processing example of changing the position of the interfering obstacle 30 to a position at which the interference is eliminated when the interference occurs in the posture. FIG. 12 is a flowchart showing a flow of processing according to Example 5 in the robot simulator 10 according to the present embodiment. The process according to Example 5 is a process performed by the determining section 13 and the controller 14 in FIG. 1.

In the flowchart of FIG. 12, each processing of steps S91 to S93 and each processing of steps S98 to S102 are the same as each processing of steps S11 to S13 and each processing of steps S17 to S21 in the flowchart of FIG. 8. Here, redundant description will be omitted.

After each process of step S93, step S99, step S101, and step S102, the determining section 13 executes the posture Pᵢ interference check with the applied clearance amount (step S94).

Next, the determining section 13 determines whether or not the result of the interference check indicates interference (step S95), and if there is no interference (NO in S95), the determining section 13 determines whether or not the posture number I is n or more (i≥n) (step S96). If the posture number I is equal to or larger than n (YES in S96), a series of processing is terminated. If the posture number I is not equal to or larger than n (NO in S96), the posture number I is incremented (step S97), and the process returns to step S92.

In step S95, if the determination result of the determining section 13 indicates that the result of the interference check indicates interference (YES in S95), in response to the determination result, the controller 14 changes the position of the interfering obstacle 30 to a different position (step S103). Specifically, the controller 14 changes the position of the interfering obstacle 30 in a direction away from the robot 20. Then, after changing the position of the interfering obstacle 30, the determining section 13 returns to step S94 and repeats the interference check.

As described above, in the processing according to Example 5, when it is determined that there is interference in the posture interference check, the position of the interfering obstacle 30 is changed to a different position and the interference check is executed. This processing is repeatedly executed until the interference is eliminated. Accordingly, when interference occurs in the posture, the position of the interfering obstacle 30 can be changed to a position at which the interference is eliminated.

By repeating the above-described processing, a position where the obstacle 30 does not interfere with the robot 20 is always found as the position of the obstacle 30 is moved away from the robot 20, and therefore, the processing may or may not be completed when the processing has been repeated a predetermined number of times.

### Example 6

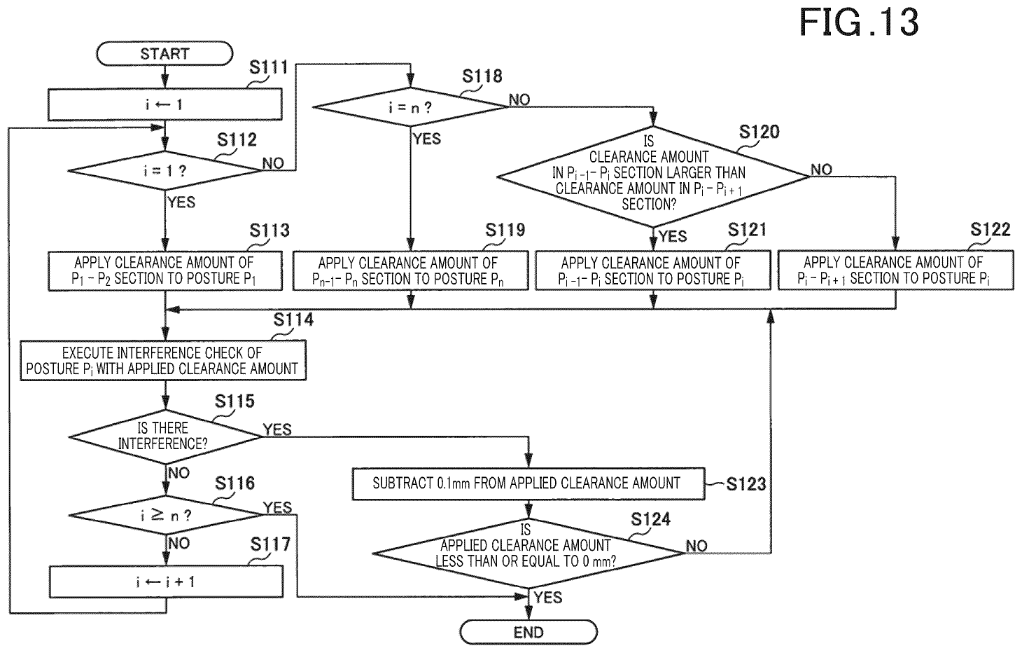

Example 6 is a processing example in which, when interference occurs in the posture, the applied clearance amount is reduced to eliminate the interference. FIG. 13 is a flowchart showing a flow of processing according to Example 6 in the robot simulator 10 according to the present embodiment. The process according to Example 6 is a process performed by the determining section 13 and the controller 14 in FIG. 1.

In the flowchart of FIG. 13, each processing of steps S111 to S113 and each processing of steps S118 to S122 are the same as each processing of steps S11 to S13 and each processing of steps S17 to S21 in the flowchart of FIG. 8. Here, redundant description will be omitted.

After each process of step S113, step S119, step S121, and step S122, the determining section 13 executes the posture Pᵢ interference check with the applied clearance amount (step S114).

Next. the determining section 13 determines whether or not the result of the interference check indicates interference (step S115), and if there is no interference (NO in S115), the determining section 13 determines whether or not the posture number I is n or more (i≥n) (step S116). If the posture number I is equal to or larger than n (YES in S116), a series of processing is terminated. If the posture number I is not equal to or larger than n (NO in S116). the posture number I is incremented (step S117), and the process returns to step S112.

In step S115, if the determination result of the determining section 13 is that the result of the interference check indicates interference (YES in S115), in response to the determination result, the controller 14 reduces the clearance amount applied to the section including the interfering posture (step S123). To be specific, for example, the controller 14 instructs the setting section 12 to perform processing of subtracting 0.1 mm from the applied clearance amount.

Next, the determining section 13 determines whether or not the clearance amount applied by the process in step S123 is equal to or less than 0 mm (step S124). Then, if the applied clearance amount is less than or equal to 0 mm (YES in S124), a series of processing ends, and if not less than or equal to 0 mm (NO in S124), the process returns to step S114 and the interference check is repeatedly executed.

As described above, in the processing according to Example 6, if it is determined that there is interference in the posture interference check, the interference check is repeatedly executed while the value of the applied clearance amount is reduced, for example, by 0.1 mm. This processing is repeated until the interference is eliminated or the value of the clearance amount becomes 0 mm or less. Thus, when the interference occurs in the posture, the value of the clearance amount to be applied can be changed to a value at which the interference is eliminated.

In the above-described processing, when the value of the clearance amount becomes equal to or smaller than the 0 mm, the determining section 13 ends the processing because the interference cannot be resolved. The amount by which the value of the clearance amount is reduced may not be 0.1 mm at a time, and may be larger or smaller than that.

### Program

The program of the present invention is a program for causing a computer to execute the processing of each functional unit of the robot simulator 10 shown in FIG. 1. More specifically, the program of the present invention is a program for causing a computer constituting the robot simulator 10 to execute processing of each function of the acquiring section 11, the setting section 12, the determining section 13, and the controller 14 illustrated in FIG. 1. The program is stored in a recording medium such as various memories, an IC card, an SD card, or an optical disc.

### Modification Example

Note that the present invention is not limited to the above-described examples, and includes various modification examples. For example, the above-described example has been described in detail in order to explain the present invention in an easy-to-understand manner, and the present invention is not necessarily limited to one including all of the described components. In addition, it is possible to replace a part of the configuration of a certain example with the configuration of another example, and it is also possible to add the configuration of another example to the configuration of a certain example.

According to an aspect of the present invention In a case where a different clearance amount is set for each section for which a route is generated, if it is determined that there is no interference in the set postures, it is possible to resolve a situation in which interference inevitably occurs in route generation.

Although embodiments of the present invention have been described and shown in detail, the disclosed embodiments are made for purposes of illustration and example only and not limitation. The scope of the present invention should be interpreted by terms of the appended claims.

The entire disclosure of Japanese Patent Application No. 2024-067300 filed on Apr. 18, 2024 is incorporated herein by reference in its entirety.

What is claimed is:

1. An information processing apparatus comprising a hardware processor that:
acquires each of information on a robot and information on an obstacle;
sets a first clearance amount in a section in which the robot changes from a first posture to a second posture and a second clearance amount in a section in which the robot changes from the second posture to a third posture; and
when determining, based on the acquired information and a set clearance amount, whether the robot and the obstacle interfere with each other in the second posture, performs determination based on a greater one of the first clearance amount and the second clearance amount.

2. The information processing apparatus according to claim 1, wherein
the information on the robot is posture information and position information of the robot, and
the information on the obstacle is position information and shape information of the obstacle.

3. The information processing apparatus according to claim 1, wherein
the hardware processor controls, based on a result of the determination, a position of the robot, a position of the obstacle, or the set clearance amount.

4. The information processing apparatus according to claim 3, wherein
upon determination that the robot and the obstacle interfere with each other, the hardware processor changes a posture of the robot to a posture in which the robot does not interfere with the obstacle.

5. The information processing apparatus according to claim 3, wherein
upon determination that the robot and the obstacle interfere with each other, the hardware processor changes a target position of a posture in which the robot interferes with the obstacle to a position where the robot does not interfere with the obstacle.

6. The information processing apparatus according to claim 3, wherein
upon determination that the robot and the obstacle interfere with each other, the hardware processor changes the position of the robot to a position where the robot does not interfere with the obstacle.

7. The information processing apparatus according to claim 3, wherein
upon determination that the robot and the obstacle interfere with each other, the hardware processor changes the position of the obstacle to a position where the obstacle does not interfere with the robot.

8. The information processing apparatus according to claim 3, wherein
upon determination that the robot and the obstacle interfere with each other, the hardware processor changes a value of a clearance amount for a section including an interfering posture to a value not causing interference.

9. An information processing method comprising:
acquiring that is acquiring each of information on a robot and information on an obstacle;
setting that is setting a first clearance amount in a section in which the robot changes from a first posture to a second posture and a second clearance amount in a section in which the robot changes from the second posture to a third posture; and
determining that is, when determining whether the robot and the obstacle interfere with each other in the second posture based on the information acquired in the acquiring and a clearance amount that is set in the setting, performing determination based on a greater one of the first clearance amount and the second clearance amount.

10. A non-transitory computer-readable recording medium storing a program for causing a computer to execute:
acquiring that is acquiring each of information on a robot and information on an obstacle;
setting that is setting a first clearance amount in a section in which the robot changes from a first posture to a second posture and a second clearance amount in a section in which the robot changes from the second posture to a third posture; and
determining that is, when determining whether the robot and the obstacle interfere with each other in the second posture based on the information acquired in the acquiring and a clearance amount that is set in the setting, performing determination based on a greater one of the first clearance amount and the second clearance amount.
